(19) United States
(12) Patent Application Publication
(10) Pub. No.: US 2019/0149787 A1
(43) Pub. Date: May 16, 2019

(54) PROJECTION SYSTEM AND IMAGE PROJECTION METHOD

(71) Applicant: Coretronic Corporation, Hsin-Chu (TW)

(72) Inventors: Chien-Chun Peng, Hsin-Chu (TW); Chi-Wei Lin, Hsin-Chu (TW); Yung-Chiao Liu, Hsin-Chu (TW)

(73) Assignee: Coretronic Corporation, Hsin-Chu (TW)

(21) Appl. No.: 16/186,491

(22) Filed: Nov. 10, 2018

(30) Foreign Application Priority Data
Nov. 15, 2017 (CN) 201711131401.0

(51) Int. Cl. H04N 9/31; G06T 7/73

(52) U.S. Cl. CPC H04N 9/3185; G06T 7/74

(57) ABSTRACT

A projection system including an image capturing device, a processing device and a projection device is provided. The image capturing device is used for capturing a first image of a projection surface. The first image includes a plurality of positioning images. The processor receives the first image. The processing device calculates to generate a plurality of positioning points according to the positioning images. The projection device projects a second image to the projection surface according to the positioning points. The second image includes a plurality of deformation points. An amount of the deformation points and an amount of the positioning points on the projection surface are consistent, such that the projected image is automatically adjusted to a range preset by the user.

### CROSS-REFERENCE TO RELATED APPLICATION

This application claims the priority benefit of China application serial no. 201711131401.0, filed on Nov. 15, 2017. The entirety of the above-mentioned patent application is hereby incorporated by reference herein and made a part of this specification.

### BACKGROUND OF THE INVENTION

### Field of the Invention

The invention relates to a projection system and an image projection method, and particularly relates to a projection system capable of adjusting a projected image according to an image captured by an image capturing device and an image projection method thereof.

### Description of Related Art

Projection device is a device capable of projecting images to a projection screen for presenting to users. An image correction function of a known projection device is generally too complicated in operation, and the user has to make multiple adjustments to a projected image in order to match the projected image with a predetermined projection region, and manual adjustment of the user is always hard to achieve a precise projection position.

When the user requires projecting an image with a specific irregular shape, the commonly used projection device does not have such function. Therefore, how to quickly and automatically adjust the image projected by the projection device to a range required by the user is a focus concerted by related technicians of the art.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY OF THE INVENTION

The invention is directed to a projection system, which is adapted to automatically adjust a projected image to a range preset by a user.

The invention is directed to an image projection method, which is adapted to automatically adjust a projected image to a range preset by a user.

Other objects and advantages of the invention can be further illustrated by the technical features broadly embodied and described as follows.

In order to achieve one or a portion of or all of the objects or other objects, an embodiment of the invention provides a projection system including an image capturing device, a processing device and a projection device. The image capturing device is used for capturing a first image of a projection surface. The first image includes a plurality of positioning images. The processor receives the first image. The processing device calculates to generate a plurality of positioning points according to the positioning images. The projection device projects a second image to the projection surface according to the positioning points. The second image includes a plurality of deformation points. An amount of the deformation points and an amount of the positioning points on the projection surface are consistent.

In order to achieve one or a portion of or all of the objects or other objects, an embodiment of the invention provides an image projection method including: capturing a first image of a projection surface, wherein the first image includes a plurality of positioning images; receiving the first image, and calculating to generate a plurality of positioning points according to the positioning images; projecting a second image to the projection surface according to the positioning points, wherein the second image includes a plurality of deformation points, and an amount of the deformation points and an amount of the positioning points on the projection surface are consistent.

According to the above description, in the projection system and the image projection method of the invention, the image of the projection surface is captured through the image capturing device. The projection device deforms the image projected to the image plane according to the image captured by the image capturing device to achieve an effect of quickly and automatically adjust a projection range to a range required by the user.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection system according to an embodiment of the invention.

FIG. 2A is a schematic diagram of a first image captured by an image capturing device of the embodiment of FIG. 1.

FIG. 2B is a schematic diagram of a second image projected by a projection device of the embodiment of FIG. 1.

FIG. 3 is a schematic diagram of a positioning image of the first image of the embodiment of FIG. 1, FIG. 2A and FIG. 2B.

FIG. 4A is a schematic diagram of a first image according to another embodiment of the invention.

FIG. 4B is a schematic diagram of a second image projected by a projection device according to another embodiment of the invention.

FIG. 5A is a schematic diagram of a reference image according to an embodiment of the invention.

FIG. 5B is a schematic diagram of a reference image according to an embodiment of the invention.

FIG. 5C is a schematic diagram of a reference image according to an embodiment of the invention.

FIG. 5D is a schematic diagram of a reference image according to an embodiment of the invention.

FIG. 6 is a flowchart illustrating an image projection method according to an embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

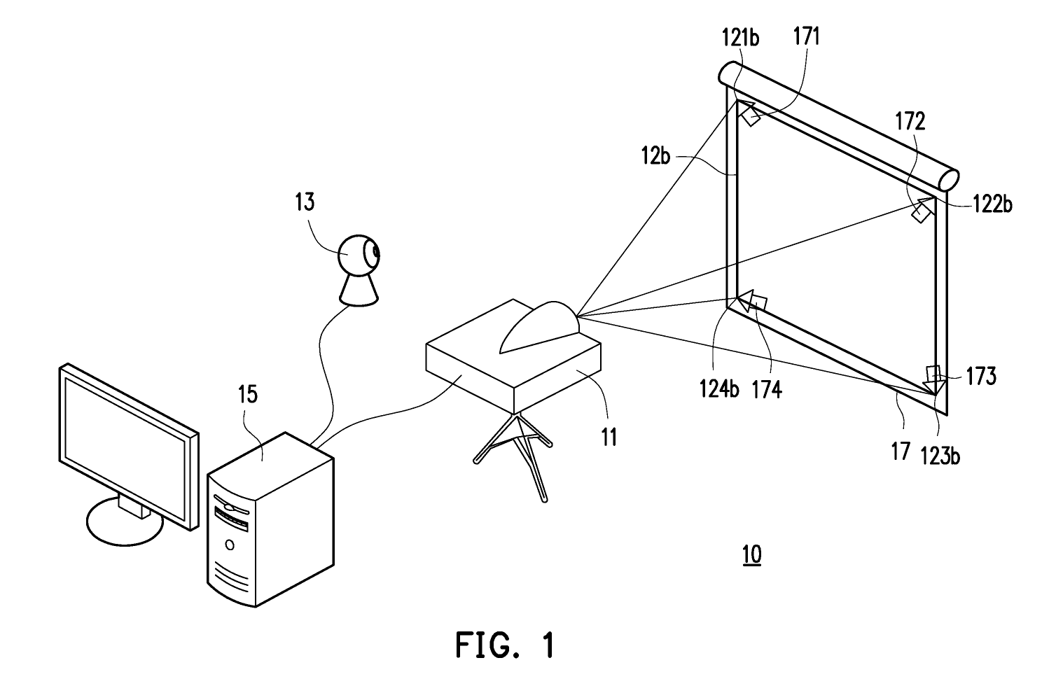

FIG. 1 is a schematic diagram of a projection system according to an embodiment of the invention. The projection system 10 of the present embodiment includes an image capturing device 13, a processing device 15 and a projection device 11. A user may dispose a plurality of positioning objects 171, 172, 173 and 174 on a projection plan 17 to set an expected projection range and a projection shape, though the invention is not limited thereto. The image capturing device 13 is used for capturing an image of the projection surface 17, and the processing device 15 may adjust image content of the processing device 15 according to the image captured by the image capturing device 13, and project the adjusted image on the projection surface 17 through the projection device 11, such that the image is complied with a position indicated by the positioning objects 171, 172, 173 and 174, and the image projected by the projection device 11 is quickly and automatically adjusted to the projection range preset by the user.

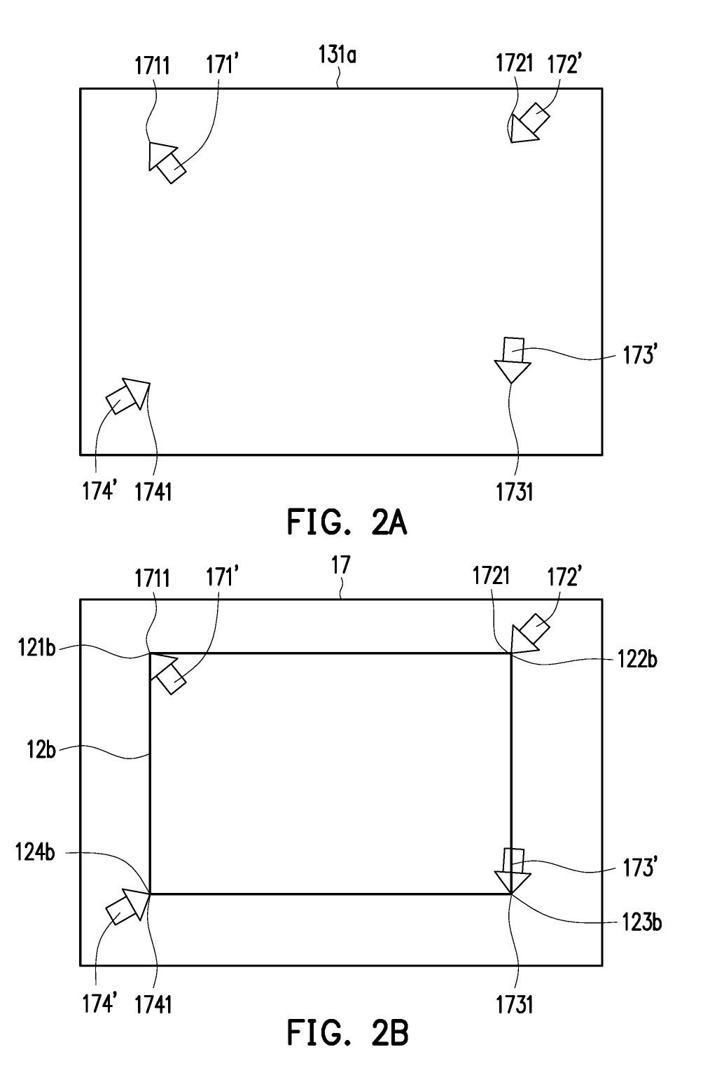

FIG. 2A is a schematic diagram of a first image 131a captured by the image capturing device 130 of the embodiment of FIG. 1. FIG. 2B is a schematic diagram of a second image 12b projected by the projection device 11 of the embodiment of FIG. 1.

Referring to FIG. 1 and FIG. 2A, the positioning objects 171, 172, 173 and 174 are disposed on the projection surface 17. The positioning objects 171, 172, 173 and 174 are adhered on the projection surface 17 by the user. The image capturing device 13 captures the first image 131a. The first image 131a includes positioning images 171′, 172′, 173′ and 174′. The positioning images 171′, 172′, 173′ and 174′ of the first image 131a are images of the positioning objects 171, 172, 173 and 174 in the first image 131a. The processing device 15 receives the first image 131a transmitted by the image capturing device 13, and transforms coordinates (a coordinate system of the image capturing device) of the positioning images 171′, 172′, 173′ and 174′ of the first image 131a into coordinates (a coordinate system of the projection device) of the image to be transmitted to the projection device 11 by the processing device 15. Further, the processing device 15 calculates to generate coordinates of a plurality of positioning points 1711, 1721, 1731 and 1741 (the coordinate system of the image capturing device) according to the positioning images 171′, 172′, 173′ and 174′ of the first image 131a, and transforms the above coordinates into coordinates (the coordinate system of the projection device) of the image to be transmitted to the projection device 11. According to the transformed coordinates of the image to be transmitted to the projection device 11, the projection device 11 projects an image with a predetermined range, i.e. the second image 12b.

Referring to FIG. 2B, the projection device 11 projects the second image 12b onto the projection surface 17 according to the coordinates (the coordinate system of the projection device) of the image transformed from the coordinates (the coordinate system of the image capturing device) of the positioning points 1711, 1721, 1731 and 1741.

The second image 12b includes a plurality of deformation points 121b, 122b, 123b and 124b. The amount of the deformation points 121b, 122b, 123b and 124b of the second image 12b is the same with the amount of the positioning points 1711, 1721, 1731 and 1741 of the first image 131a, and the positioning points 1711, 1721, 1731 and 1741 of the positioning objects 171, 172, 173 and 174 are within the predetermined range of the image projected by the projection device 11.

In other embodiments, the second image 12b projected to the projection surface 17 by the projection device 11 is deformed, such that a range of the second image 12b may be complied with the positions of the positioning points 1711, 1721, 1731 and 1741, and the image projected by the projection device 11 may be quickly and automatically adjusted to the range indicated by the positioning objects 171, 172, 173 and 174. Details thereof are described below.

In an embodiment, referring to FIG. 2B, when the projection device 11 projects the second image 12b to the projection surface 17, the deformation points 121b, 122b, 123b and 124b of the second image 12b are not complied with the positioning points 1711, 1721, 1731 and 1741 of the first image 131a. Now, the processing device 15 controls the projection device 11 to adjust the deformation points 121b, 122b, 123b and 124b to be complied with the positioning points 1711, 1721, 1731 and 1741. In this way, the projected image may be deformed.

Therefore, the user is only required to dispose the positioning objects 171, 172, 173 and 174 on the projection surface 17 to position a predetermined projection range of image, the projection system 10 may quickly and automatically adjust the second image 12b projected by the projection device 11 for complying with the range required by the user. In the projection system 10 of the present embodiment, 4 positioning objects 171, 172, 173 and 174 are taken as an example for description, and the second image 12b, for example, has 4 deformation points 121b, 122b, 123b and 124b, though the invention is not limited thereto. In other embodiments of the invention, the projection system may have a plurality of positioning objects, and the second image may have a plurality of corresponding deformation points. The user may dispose the positioning objects on the projection surface in any shape to position the predetermined projection range, and the projection system may quickly and automatically adjust the second image to the range required by the user.

The type and form of the positioning objects 171, 172, 173 and 174 are not limited by the invention as long as the positioning objects 171, 172, 173 and 174 may be disposed on the projection surface 17 by the user. For example, the positioning objects 171, 172, 173 and 174 are, for example, magnetic objects, papers or stickers, which may be easily disposed on the projection surface 17 by the user, and the positioning objects 171, 172, 173 and 174 may also be coated, printed or drawn on the projection surface 17, and may be wiped off. It should be noted that the positioning objects 171, 172, 173 and 174 disposed on the projection surface 17 are within an image capturing range of the image capturing device 13, and the positioning points 1711, 1721, 1731 and 1741 are within the projection range of the projection device 11, such that the first image 131a may include the positioning images 171′, 172′, 173′ and 174′.

In an embodiment, the image capturing device 13 is, for example, a digital video camera or a digital camera having a photo-sensing device such as a charge-coupled device (CCD) or a complementary metal-oxide-semiconductor (CMOS) device, etc., and the image capturing device 13 may be an independent device, and is connected to the processing device 15 through a wired or wireless manner. The image capturing device 13 may also be a device disposed on the projection device 11, and the projection device 11 is connected to the processing device 15 through a wired or wireless manner, and the image capturing device 13 is externally connected to or embedded in the projection device 11, though the invention is not limited thereto. The processing device 15 is, for example, an electronic device such as a desktop computer, a notebook computer, a tablet computer or a smart phone, etc., and the processing device 15 may also be a processing circuit disposed in the projection device 11. The projection surface 17 is, for example, a projection screen, a wall or a billboard, etc., and the projection plane is not limited to a surface, which is not limited by the invention.

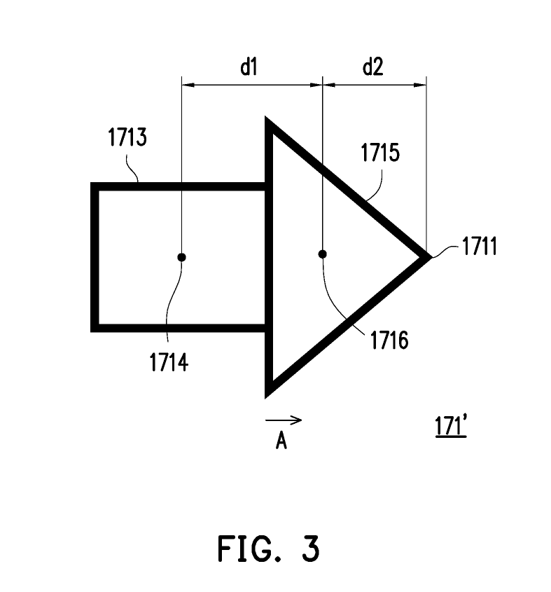

To be specific, the positioning images 171′, 172′, 173′ and 174′ of the first image 131a may respectively include a plurality of object images, and the processing device 15 calculates to generate the positioning points 1711, 1721, 1731 and 1741 corresponding to each of the positioning images 171′, 172′, 173′ and 174′ according to center points of the object images. Referring to FIG. 3, FIG. 3 is a schematic diagram of the positioning image 171′ of the first image 131a of the embodiment of FIG. 1 and FIG. 2A. The object images of the positioning image 171′ include a first geometric figure (for example, a first polygon) 1713 and a second geometric figure (for example, a second polygon) 1715, and the center points of the object images are respectively a geometric center 1714 of the first polygon 1713 and a geometric center 1716 of the second polygon 1715, though the amount of the object images is not limited by the invention. In other embodiments, the positioning points 1711, 1721, 1731 and 1741 are calculated according to feature points (for example, a corner position point) of each of the object images, and are not limited to the geometric centers.

The processing device 15 may calculate to generate the positioning point 1711 according to the geometric centers 1714 and 1716 through an interpolation method, though the invention is not limited thereto, and the interpolation method is only one of the possible methods. In the present embodiment, the processing device 15 may obtain positions of the geometric centers 1714 and 1716 through image recognition, and calculate to generate a distance d1 between the geometric centers 1714 and 1716, and a direction that the first polygon 1713 faces the second polygon 1715 is a direction A. The processing device 15 may calculate to generate a distance d2 according to the distance d1, and extend the geometric center 1716 towards the direction A by the distance d2 to obtain the position of the positioning point 1711. The distance d2 and coordinates of the positioning point 1711 calculated by the processing device 15 may be preset in a storage device (for example, a memory, not shown) of the processing device 15 according to a type or a form of the positioning objects 171, 172, 173 and 174. The method that the processing device 15 calculates to generate coordinates of the positioning points 1721, 1731 and 1741 corresponding to the positioning images 172′, 173′ and 174′ is the same to the method of obtaining the positioning image 171′, and detail thereof is not repeated. In the present embodiment, the first polygon 1713 is, for example, a rectangle, and the second polygon 1715 is, for example, a triangle, and the positioning point 1711 is located at a tip of the second polygon 1715 away from the first polygon 1713. Through the design that each of the positioning images includes a plurality of object images, the processing device 150 may calculate to generate the positions (coordinates) of the positioning points of the positioning images. When the processing device 15 calculates to generate the positioning points 1711, 1721, 1731 and 1741, the processing device 15 is not influenced by configuration angles of the positioning objects 171, 172, 173 and 174 disposed on the projection surface 17. For example, in the present embodiment, regardless how the positioning image 171′ composed of the first polygon 1713 and the second polygon 1715 horizontally moves and rotates, the positioning point 1711 may all be found, and the processing device 15 may calculate to obtain the positioning point 1711. The amount of the object images included in each of the positioning images of the present embodiment, the shape of each of the object images and the calculation method of the interpolation method are only used as an example, and the invention is not limited thereto. Moreover, the positioning objects 171, 172, 173 and 174 are, for example, figures having a high contrast (for example, figures with a white background and black lines or black background and white lines), such that the positioning images 171′, 172′, 173′ and 174′ in the first image 131a and the object images thereof are recognized by the processing device 15 through the image capturing device 13.

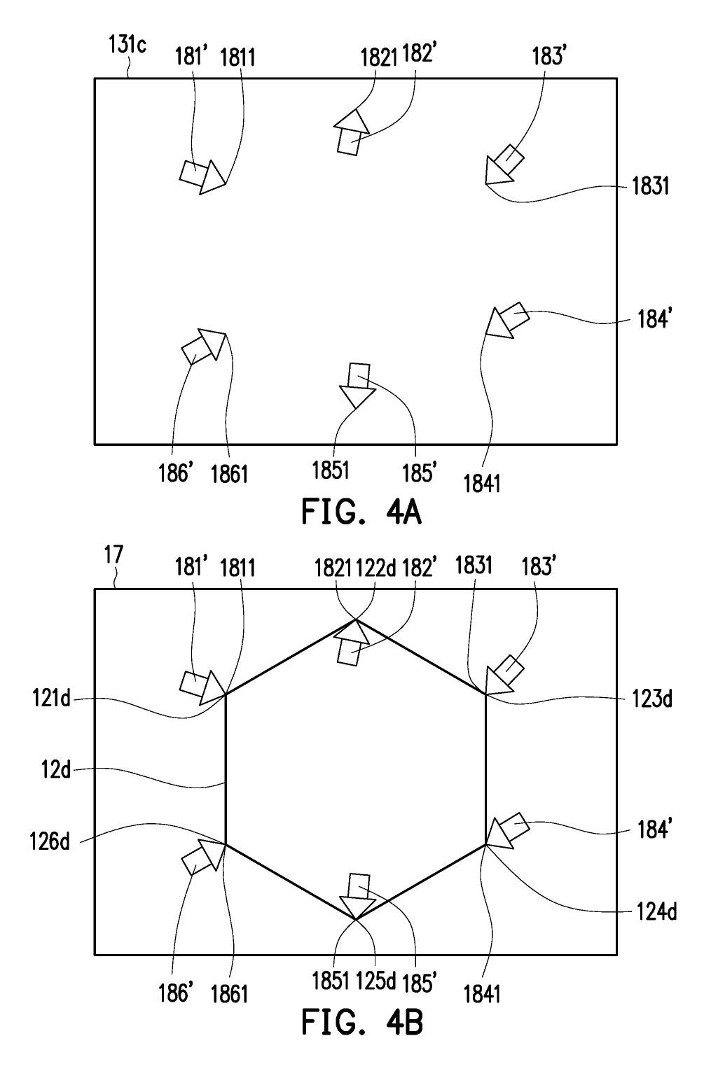

In detail, the positioning points 1711, 1721, 1731 and 1741 of the positioning images 171′, 172′, 173′ and 174′ are distributed in the first image 131a in a predetermined sequence, i.e. the processing device 15 executes image processing in a sequence of an upper left corner, an upper right corner, a lower right corner and a lower left corner of the first image 131a, and the deformation points 121b, 122b, 123b and 124b are also distributed in the second image 12b in a same predetermined sequence, though the invention is not limited thereto. When the projection device 11 projects the second image 12b to the projection surface 17, the projection device 11 adjusts the positions of the deformation points 121b, 122b, 123b on the projection surface 17 to be complied with the positions of the positioning points 1711, 1721, 1731 and 1741 according to the predetermined sequence, such that the second image 12b projected to the projection surface 17 has a deformation shown in FIG. 2B. For example, the predetermined sequence may be that the positioning point 1711 is a first positioning point, the positioning point 1721 is a second positioning point, the positioning point 1731 is a third positioning point and the positioning point 1741 is a fourth positioning point. The deformation point 121b is a first deformation point, the deformation point 122b is a second deformation point, the deformation point 123b is a third deformation point and the deformation point 124b is a fourth deformation point. The projection device 11 first adjusts the position of the deformation point 121b on the projection surface 17 to be complied with the position of the positioning point 1711 according to the predetermined sequence, and then sequentially adjusts the deformation points 122b, 123b, 124b to be complied with the positioning points 1721, 1731, 1741 to project the second image 12b, so as to cope with the range preset by the user. FIG. 4A is a schematic diagram of a first image 131c according to another embodiment of the invention. FIG. 4B is a schematic diagram of a second image 12d projected by the projection device 11 according to another embodiment of the invention. In FIG. 4B, the deformed second image 12d produced after image processing of the processing device 15 is illustrated. Referring to FIG. 4A and FIG. 4B, the projection system of the present embodiment has a similar structure and function with that of the projection system 10 of FIG. 1, and a difference between the present embodiment and the embodiment of FIG. 1 to FIG. 3 is that the projection system of the present embodiment has 6 positioning objects (not shown), and the second image 12d has 6 deformation points 121d, 122d, 123d, 124d, 125d and 126d. The first image 131c has positioning images 181′, 182′, 183′, 184′, 185′, 186′ and corresponding positioning points 1811, 1821, 1831, 1841, 1851, 1861. When the projection device 11 projects the second image 12d to the projection surface 17, the deformation points 121d, 122d, 123d, 124d, 125d and 126d of the second image 12d are not complied with the positioning points 1811, 1821, 1831, 1841, 1851, 1861 of the first image 131c. Now, the processing device 15 may control the projection device 11 to adjust the positions and the amount of the deformation points 121d, 122d, 123d, 124d, 125d and 126d on the projection surface 17 to be complied with the positions and the amount of the positioning points 1811, 1821, 1831, 1841, 1851, 1861, such that he projected image is deformed to obtain the second image 12d shown in FIG. 4B.

In the present embodiment, a predetermined sequence of the positioning points 1811, 1821, 1831, 1841, 1851, 1861 in the first image 131c is, for example, first to sixth positioning points, and a predetermined sequence of the deformation points 121d, 122d, 123d, 124d, 125d and 126d in the second image 12d is also first to sixth deformation points. Therefore, when the projection device 11 projects the second image 12d to the projection surface 17, the projection device 11 adjusts the positions of the deformation points 121d, 122d, 123d, 124d, 125d and 126d on the projection surface 17 to be complied with the positions of the positioning points 1811, 1821, 1831, 1841, 1851 and 1861 according to the predetermined sequence, such that the second image 12d projected to the projection surface 17 has a deformation to cope with a projection range required by the user. In the present embodiment, a hexagonal projection range is taken as an example for description, though in an actual application, the user may set a plurality of positioning objects on the projection surface 17 to project an image of any shape according to an actual requirement.

It should be noted that in the embodiment of FIG. 1 to FIG. 3, before the processing device 15 automatically adjusts the projected image, the projection device 11 may first project a plurality of reference images to the projection surface 17, and the positioning points 1711, 1721, 1731 and 1741 of the positioning objects 171, 172, 173 and 174 on the projection surface 17 are within a range of the images projected by the projection device 11. The image capturing device 13 captures the reference images, and the processing device 15 identifies the projection range of the projection device 11 according to the captured reference images, so as to ensure that the positioning objects 171, 172, 173 and 174 attached to the projection surface 17 are within an image capturing range of the image capturing device 13, and the first image 131a may include the positioning images 171′, 172′, 173′ and 174′.

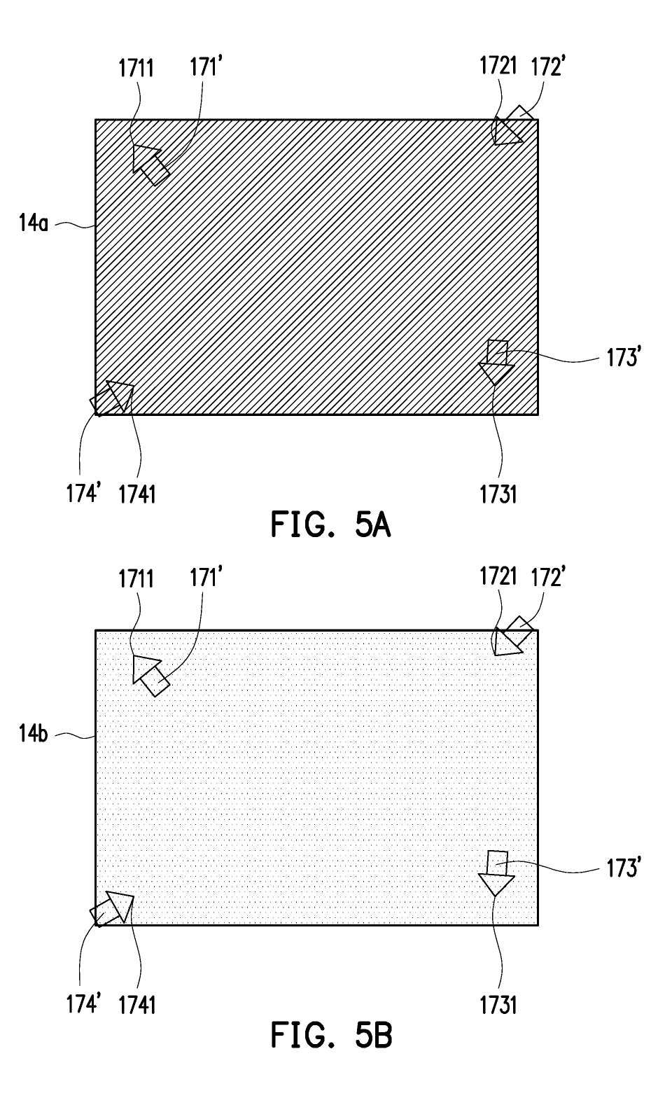

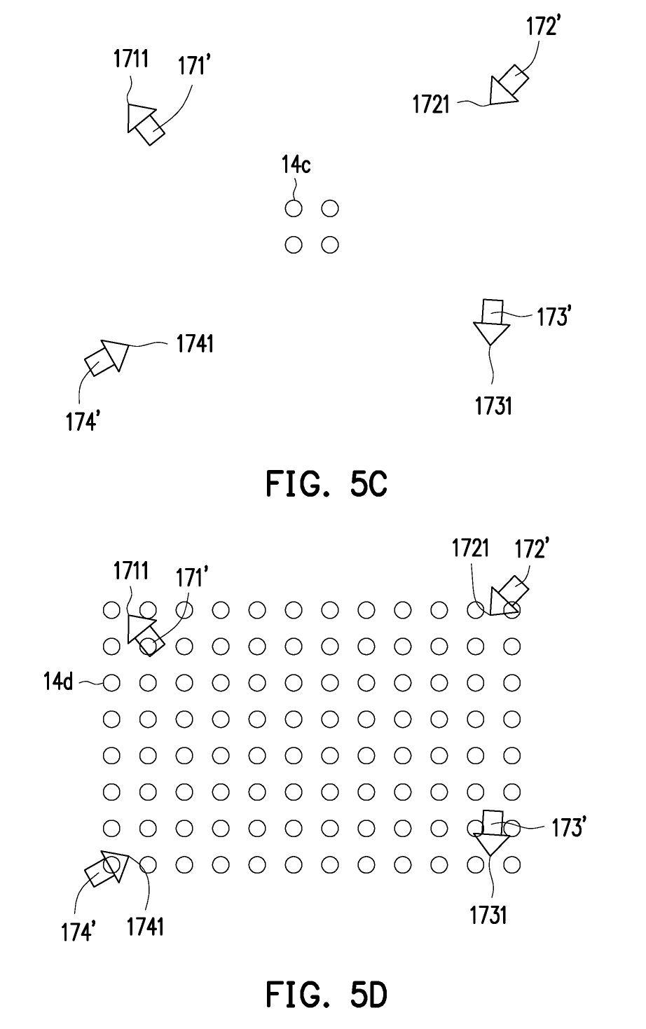

FIG. 5A to FIG. 5D are schematic diagrams of reference images according to an embodiment of the invention, which represents a processing flow of a coordinate system of a coordinate system conversion device of the image capturing device. As shown in FIG. 5A, the reference image 14a projected to the projection surface 17 by the projection device 11 is a full black image, and the positioning points 1711, 1721, 1731 and 1741 are located within a range of the reference image 14a. As shown in FIG. 5B, the reference image 14b is a full white image, and the positioning points 1711, 1721, 1731 and 1741 are located within a range of the reference image 14b. As shown in FIG. 5C, the reference image 14c is a first point array image. In the present embodiment, the first point array image is, for example, 4 round balls located in a middle region of the projection surface 17. As shown in FIG. 5D, the reference image 14d is a second point array image. In the present embodiment, the second point array image is obtained according to the first point array image. In the present embodiment, the second point array image is a round ball array obtained by extending the 4 round balls of the reference image 14c towards an edge of the projection surface 17, and the round ball array fills the projection range of the projection device 11 by using, for example, an interpolation or extrapolation method.

The processing device 15 may identify the projection range of the projection device 11 according to the reference images 14a, 14b, 14c, 14d captured by the image capturing device 13. In other words, the processing device 15 may obtain a conversion relationship between a coordinate system of the image capturing device 13 and a coordinate system of the projection device 11, and store the same in the storage device of the processing device 15.

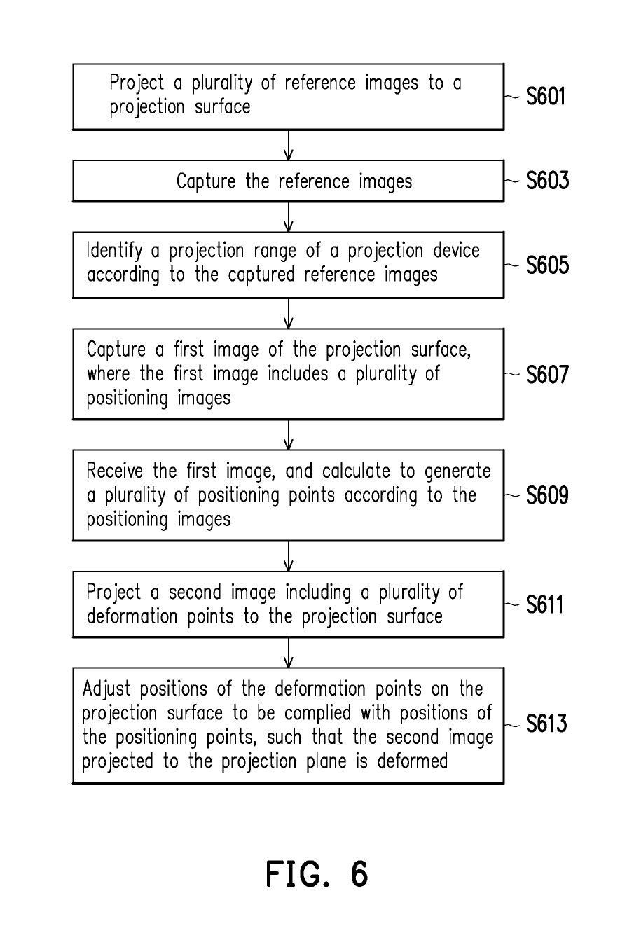

FIG. 6 is a flowchart illustrating an image projection method according to an embodiment of the invention. Referring to FIG. 6, in step S601, a plurality of reference images is projected to a projection surface. Then, in step 5603, the image capturing device 13 is applied to capture the reference images. In step 5605, a projection range of a projection device is identified according to the captured reference images, and the processing device 15 obtains a conversion relationship between a coordinate system of the image capturing device 13 and a coordinate system of the projection device 11. Then, in step 5607, a first image of the projection surface is captured, where the first image includes a plurality of positioning images. In step S609, the first image is received, and a plurality of positioning points is calculated according to the positioning images. Then, in step S611, a second image including a plurality of deformation points is projected to the projection surface. In step S613, positions of the deformation points on the projection surface are adjusted to be complied with positions of the positioning points, such that the second image projected to the projection surface is deformed, which is achieved by using the conversion relationship between the coordinate system of the image capturing device 13 and the coordinate system of the projection device 11. Therefore, a range of the second image may be complied with the positions of the positioning points.

Moreover, enough instructions and recommendations for the image projection method of the invention may be learned from the descriptions of the embodiments of FIG. 1 to FIG. 5D, and detailed description thereof is not repeated.

In summary, in the projection system and the image projection method of the invention, the first image of the projection surface is captured through the image capturing device. The first image includes a plurality of positioning images. The processing device receives the first image, and calculates to generate a plurality of positioning points according to the positioning images. The projection device projects the second image to the projection surface according to the positioning points, such that the second image projected to the projection surface is deformed. Therefore, the second image projected by the projection device may be quickly and automatically adjusted to the projection range required by the user.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection system, comprising:
an image capturing device, adapted to capture a first image of a projection surface, wherein the first image comprises a plurality of positioning images;
a processing device, adapted to receive the first image, and calculate to generate a plurality of positioning points according to the positioning images; and
a projection device, adapted to project a second image to the projection surface according to the positioning points, wherein the second image comprises a plurality of deformation points,
wherein an amount of the deformation points and an amount of the positioning points on the projection surface are consistent.

2. The projection system of claim 1, wherein each of the positioning images comprises a plurality of object images, and the processing device calculates to generate the positioning points corresponding to the positioning images according to feature points of the object images.

3. The projection system of claim 1, wherein the object images comprise a first geometric figure and a second geometric figure, the feature points of the object images are a feature point of the first geometric figure and a feature point of the second geometric figure, and the processing device calculates to generate the positioning points according to a relative position relationship of the feature points.

4. The projection system of claim 1, wherein the projection surface comprises a plurality of positioning objects, the positioning objects is adhered to the projection surface by a user, and the positioning images are images of the positioning objects in the first image.

5. The projection system of claim 4, wherein the positioning points of the positioning objects adhered to the projection surface are within an image capturing range of the image capturing device, and within a projection range of the projection device.

6. The projection system of claim 4, wherein the positioning points are within a projection range of the projection device.

7. The projection system of claim 4, wherein the projection device projects a plurality of reference images to the projection surface, the image capturing device captures the reference images, and the processing device identifies a projection range of the projection device according to the reference images captured by the image capturing device.

8. The projection system of claim 7, wherein the reference images comprise a full black image, a full white image, a first point array image and a second point array image, wherein the second point array image is obtained according to the first point array image.

9. The projection system of claim 1, wherein the positioning points are distributed in the first image in a predetermined sequence, and the deformation points are distributed in the second image in the predetermined sequence, wherein when the projection device projects the second image to the projection surface, positions of the deformation points on the projection surface are adjusted to be complied with positions of the positioning points, such that the second image projected to the projection surface is deformed.

10. An image projection method, comprising:
capturing a first image of a projection surface, wherein the first image comprises a plurality of positioning images;
receiving the first image, and calculating to generate a plurality of positioning points according to the positioning images; and
projecting a second image to the projection surface according to the positioning points, wherein the second image comprises a plurality of deformation points, and an amount of the deformation points and an amount of the positioning points on the projection surface are consistent.

11. The image projection method of claim 10, wherein each of the positioning images comprises a plurality of object images, and the positioning points corresponding to the positioning images are calculated according to feature points of the object images.

12. The image projection method of claim 10, wherein the object images comprise a first geometric figure and a second geometric figure, the feature points of the object images are geometric centers of the first geometric figure and the second geometric figure.

13. The image projection method of claim 10, wherein the projection surface comprises a plurality of positioning objects, the positioning objects is adhered to the projection surface by a user, and the positioning images are images of the positioning objects in the first image.

14. The image projection method of claim 13, wherein the positioning objects adhered to the projection surface are within an image capturing range of the image capturing device, and within a projection range of the projection device.

15. The image projection method of claim 13, wherein the positioning points are within a projection range of the projection device.

16. The image projection method of claim 15, further comprising:
projecting a plurality of reference images to the projection surface;
capturing the reference images; and
identifying the projection range according to the captured reference images.

17. The image projection method of claim 16, wherein the reference images comprise a full black image, a full white image, a first point array image and a second point array image, wherein the second point array image is obtained according to the first point array image.

18. The image projection method of claim 10, wherein the positioning points are distributed in the first image in a predetermined sequence, and the deformation points are distributed in the second image in the predetermined sequence, wherein the step of projecting the second image to the projection surface according to the positioning points comprises:
when the second image is projected to the projection surface, complying positions of the deformation points on the projection surface with positions of the positioning points.
